(19) United States
(12) Patent Application Publication
(10) Pub. No.: US 2007/0106695 A1
(43) Pub. Date: May 10, 2007

(54) INFORMATION PROCESSING APPARATUS, METHOD, AND SYSTEM

(75) Inventor: Hiroyasu MIYAZAWA, Ohta-ku, Tokyo (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/553,595

(22) Filed: Oct. 27, 2006

(30) Foreign Application Priority Data
Nov. 4, 2005 (JP) 2005-321394

(51) Int. Cl. G06F 17/00

(52) U.S. Cl. 707/104.1

(57) ABSTRACT

An information processing method that manages flow information that defines a cooperation processing of a plurality of tasks acquires update information that depicts a task that is subject to updating and a task structure for the relevant task after updating. It also detects task information, from flow information registered in the system, that corresponds to the task that is indicated as subject to updating by the update information. The method then updates the flow information in question by relating and describing information that depicts the post-update task structure with regard to the task information that has been located in the flow information.

### BACKGROUND OF THE INVENTION

1. Field of the Invention

The present invention relates to generating and executing job flow that defines task cooperation.

2. Description of the Related Art

Conventionally, many attempts have been made to build systems that facilitate settings that link and execute multiple processes to be performed on document data (settings for cooperation of multiple processes), using apparatuses connected via networks. Attempts have also been made to reuse these settings for linking multiple processes through other, external apparatuses. An assembly that generates instruction data that links multiple processes and facilitates reusing of this data through other, external apparatuses, is described in Japanese Patent Laid-Open No. 2004-287860.

Hereinafter, a process subject to these links (cooperation) will be referred to as a “task”. Additionally, the data that regulates task cooperation will be referred to as “job flow definition information” for the purposes of this specification.

Unfortunately, where service process apparatuses such as that described in Japanese Patent Laid-Open No. 2004-287860 are concerned, no consideration is given to the compatibility of legacy instruction data when linked tasks are updated. Consequently, if an update is carried out, for example, a task's functions being subdivided, resulting in functions that had been performed under a single task up to that point being performed under multiple tasks, administrators will have to change instruction data manually. There is also a demand for administrators being able to easily create instruction data (job flow definition information) through combinations of new versions when linked tasks are updated.

### SUMMARY OF THE INVENTION

The present invention, addressing the aforementioned concerns, has as its objective allowing automated updates of job flow definition information in response to task updates, and improving usability in task cooperation processing systems.

According to one aspect of the present invention, there is provided an information processing method for managing flow information that defines a cooperation processing of a plurality of tasks, the method comprising: an acquiring step of acquiring update information that depicts a task that is subject to updating and a task structure of the task after updating; a detecting step of detecting task information corresponding to a task that is subject to updating, indicated by the update information, from registered flow information; and an updating step of updating the flow information by adding, to the task information detected by the detecting step, information that depicts a task structure after updating that is depicted in the update information.

Furthermore, according to another aspect of the present invention, there is provided an information processing method that processes the display of tasks for structuring flow information that defines a cooperation processing of a plurality of tasks, the method comprising: a determination step of determining, in accordance with task information for a task to be displayed, whether or not the task is being subdivided into a plurality of tasks; a first displaying step of displaying the task in a first format in the event that it is determined in the determination step that the task is being subdivided, and in a second format that differs from the first format in the event that it is determined in the determination step that the task is not being subdivided; and a second displaying step of displaying a task as a plurality of subdivided tasks in the event that the task is directed as being displayed in the first format.

Furthermore according to another aspect of the present invention, there is provided an information processing method that executes a task in accordance with flow information that defines a cooperation processing of a plurality of tasks, comprising: a first acquisition step of acquiring the next task to be executed, in accordance with task information contained in flow information; a determination step of determining whether or not the task information acquired in the first acquisition step is being subdivided into a plurality of tasks; a second acquisition step of acquiring the plurality of tasks in the event that it is determined that subdivision is taking place; and an execution step of executing the task acquired in either the first acquisition step or the second acquisition step.

Furthermore according to another aspect of the present invention, there is provided an information processing apparatus that manages flow information that defines a cooperation processing of a plurality of tasks, comprising: an acquisition unit adapted to acquire update information that depicts a task subject to updating and a structure of the task after updating; a detection unit adapted to detect task information, from registered flow information, corresponding to a task that is subject to updating, indicated by the update information; and an update unit adapted to update the flow information by adding, to the task information detected by the detection unit, information that depicts task structure after updating that is depicted in the update information.

Furthermore according to another aspect of the present invention, there is provided an information processing apparatus that display processes a task for constituting flow information that defines a cooperation processing of a plurality of tasks, comprising: a determination unit adapted to determine whether or not a task to be displayed is being subdivided into a plurality of tasks, in accordance with task information of the task; a first display unit adapted to display the task in a first format in the event that it is determined by the determination unit that the task is being subdivided, and in a second format that differs from the first format in the event that it is determined by the determination unit that the task is not being subdivided; and a second display unit adapted to display a task as a plurality of subdivided tasks in the event that the task displayed in the first format is directed.

According to another aspect of the present invention, there is provided an information processing apparatus that executes a task in accordance with flow information that defines a cooperation processing of a plurality of tasks, comprising: a first acquisition unit adapted to acquire the next task to be executed, in accordance with task information contained in flow information; a determination unit adapted to determine whether or not the task information acquired by the first acquisition unit is being subdivided into a plurality of tasks; a second acquisition unit adapted to acquire the plurality of tasks in the event that it is determined that subdivision is taking place according to the determination unit; and an execution unit adapted to execute the task acquired by either the first or second acquisition unit.

According to another aspect of the present invention, there is provided an information processing system wherein a plurality of information processing apparatuses are connected via networks that possesses a server apparatus that registers and manages a task's task information and flow information that defines a cooperation processing of a plurality of tasks, comprising: a generation unit adapted to generate, and supply to the server apparatus, update task information that depicts task structures before and after updating for a task that is subject to updating; a detection unit adapted to detect task information that corresponds to a task that is subject to updating as depicted by the update task information, from flow information registered with the server apparatus; a first update unit adapted to update the flow information by adding, to the task information detected by the detection unit, information that depicts task structure after update depicted in the update task information; and a second update unit adapted to use the task information to update a corresponding task registered on the server apparatus.

Further features of the present invention will become apparent from the following description of exemplary embodiments with reference to the attached drawings.

### BRIEF DESCRIPTION OF THE DRAWINGS

FIG. 1 is a block diagram of a task cooperation processing system according to the embodiment.

FIG. 2A is a diagram showing operation flow in the task cooperation processing system shown in FIG. 1, from application registration to creating and executing job flow.

FIG. 2B is a diagram showing operation flow in the task cooperation processing system shown in FIG. 1, from application registration to creating and executing job flow.

FIG. 3 depicts a data structure of task definition information according to the embodiment.

FIG. 4A is a schematic depiction of job flow definition information according to the embodiment.

FIG. 4B is an example of the job flow definition information depicted in FIG. 4A coded in XML.

FIG. 5 is an example of job flow definition information for describing task function partitioning due to application updates.

FIG. 6 is a flowchart describing an overview of automated update processing of job flow definition information due to application updates.

FIG. 7 is a flowchart describing automated update processing of job flow definition information according to the embodiment.

FIG. 8 is a flowchart describing automated update processing of job flow definition information according to the embodiment.

FIG. 9 is a flowchart describing task execution processing according to a new version of job flow definition information.

FIG. 10 is a flowchart describing processing executing a substitute task according to a new version of job flow definition information.

FIG. 11 is a flowchart describing processing executing tasks in parallel according to a new version of job flow definition information.

FIG. 12A is an example of a user interface during job flow execution.

FIG. 12B is an example of a user interface during job flow execution following automated updating of job flow definition information.

FIG. 12C is an example of a user interface during execution of job flow created following of interface information updated by application updates.

FIGS. 13A to 13C describe task interface information contained in applications.

FIGS. 14A to 14C describe examples of job flow definition information.

FIGS. 15A to 15C depict examples of user interfaces of job flow creation editors, which edit job flow definition information.

FIG. 16 is a flowchart describing job flow display processing.

FIG. 17 is a flowchart describing display processing of task icons when creating and editing job flow.

### DESCRIPTION OF THE EMBODIMENTS

Preferred embodiments of the present invention will now be described in detail in accordance with the accompanying drawings.

This section will begin by describing the system configurations and application configurations to which the present invention is applicable.

System Configurations

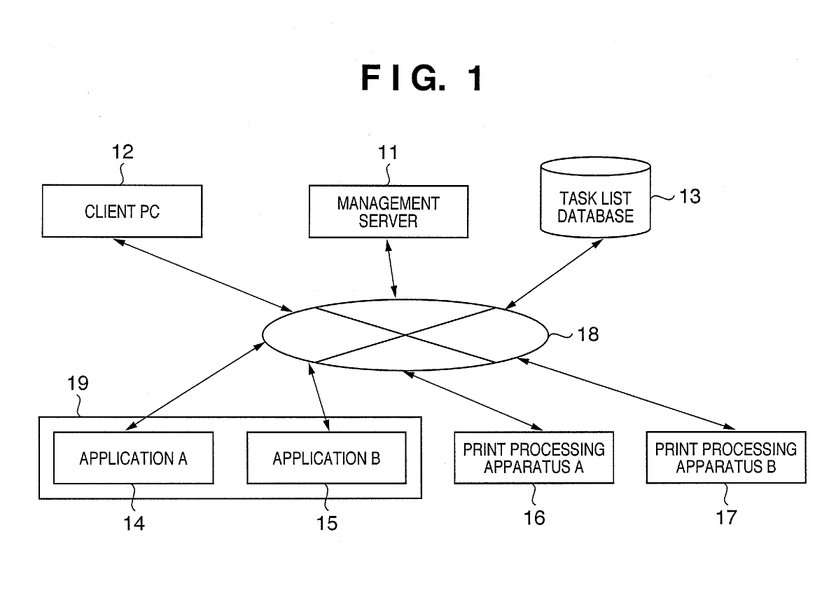

FIG. 1 is a block diagram of a task cooperation processing system according to the embodiment. Task cooperation processing systems are systems capable of linked execution of a variety of tasks (cooperation of a variety of tasks), including print processing apparatus tasks, from print processing apparatuses or information processing apparatuses.

Note that, within the embodiment, tasks refer to processes capable of being executed on document data. Examples of print processing apparatus tasks, for instance, would include copying, scanning, fax transmission, storage on hard drives within print processing apparatuses, or sending by e-mail, of document data. Tasks applicable to the present invention are not restricted to these, of course. The task cooperation processing system is also capable of linking with a plurality of applications that are capable of supplying a variety of tasks, aside from the print processing apparatus that provides the aforementioned tasks. The embodiment defines a print processing apparatus and application capable of executing tasks as a task processing apparatus. Note that information processing apparatuses, such as personal computers, are examples of apparatuses that execute applications capable of executing tasks.

In a task cooperation processing system, management server 11, client PC 12, task list database (DB) 13, application A14, application B15, print processing apparatus A16, and print processing apparatus B17 are linked with each other via a network 18. Note that, application A14 depicts application A executed by information processing apparatus 19, and application B15 depicts application B executed by information processing apparatus 19. The number of applications and print processing apparatuses are not restricted to those given in the diagram. Task list database 13 has no format restrictions whatsoever. For example, the task list database 13 may be provided on a per application basis or provided aside from management of tasks of a print processing apparatus. Additionally, the information processing apparatuses executing application A14 and application B15 need not be the same. Hereinafter, however, a description follows of a task cooperation processing system connecting two applications (application A14, application B15) and two print processing apparatuses (print processing apparatus A16, print processing apparatus B17), as shown in FIG. 1.

Management server 11 conducts management of the task processing apparatuses such as application A14, application B15, print processing apparatus A16 and print processing apparatus B17, and manages the tasks that the respective task processing apparatuses are capable of executing with task list database (DB) 13. Client PC 12 obtains a desired executable task from the tasks registered in task list database 13, by way of management server 11, and uses the task to create a job flow. Note that a job flow depicts a sequence of processes derived by combining a plurality of tasks. A job flow is a unit of execution as a single job, or in other words, a unit of a plurality of tasks executed one after another. The created job flow is managed by management server 11, and can be executed either by print processing apparatus A16, print processing apparatus B17 or any devices connected via network 18 (not shown).

Operation Flow

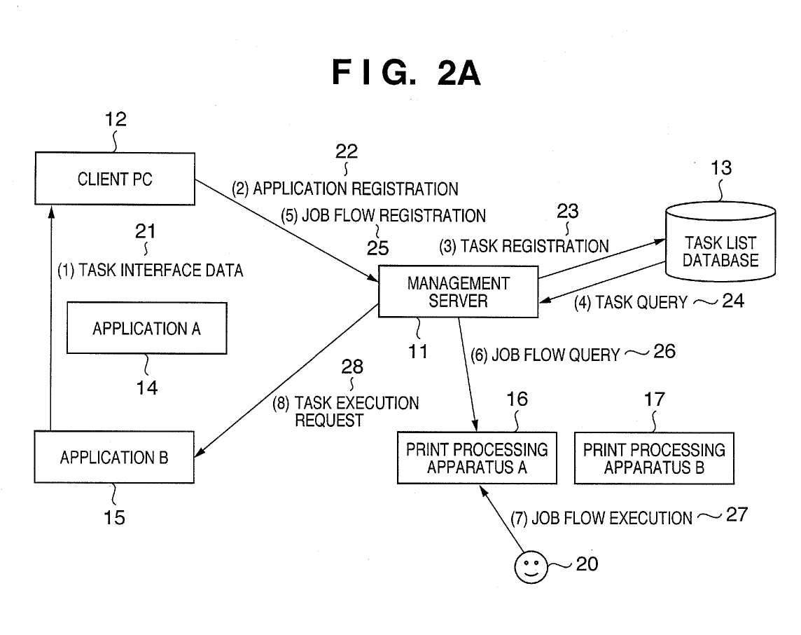

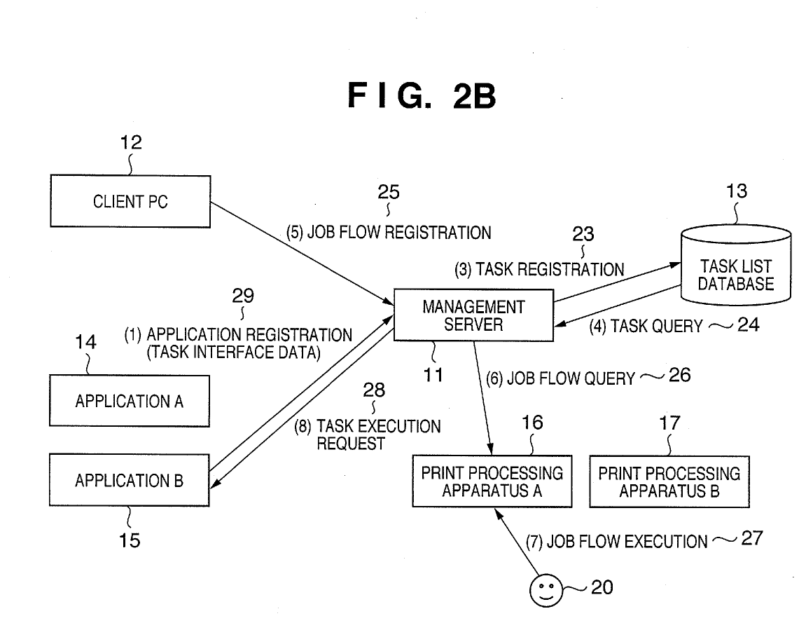

FIGS. 2A and 2B depict an operation flow of the task cooperation processing system for the embodiment, from adding a new application (an application containing tasks capable of being used in a job flow) to job flow execution. Note that FIG. 2A shows the process of conducting application registration via client PC 12, and FIG. 2B shows the process of conducting application registration without going through client PC 12.

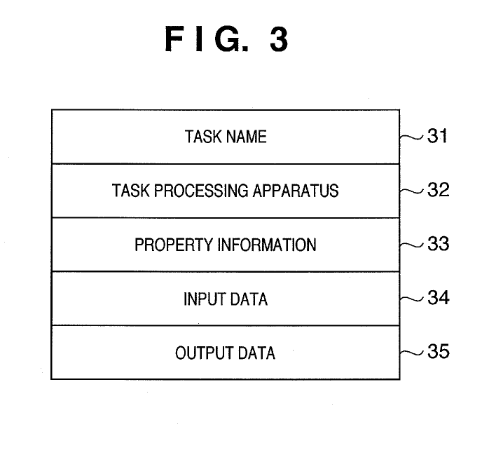

This section describes conducting application registration via client PC 12 (FIG. 2A), as adding application B15 as a new entry. Client PC 12 obtains the task interface information for the newly entered application B15 from application B15 (21). The task interface information contains, for example, definitions of the input data required by the task in question, and of the output data obtained by executing the task in question. Next, the application information, including the acquired task interface information, is sent to the management server 11 from the client PC 12 (22), which requests registration for the application in question. Management server 11, upon receipt of the application information and the request for application registration, performs registering task information of the application B15 in task list database 13 (23). At this point, management server 11 generates task definition information based on the task interface information, as will be depicted with reference to FIG. 3, and registers this information in task list database 13. In this way, tasks that can be executed by application B15 are registered in task list database 13.

Once registration processing of the sort described in the preceding section is completed, it is possible to create job flows including the application B 15 task. Job flow creation is done by client PC 12, for example. When creating a job flow, client PC 12 queries the task list registered in task list database 13, via management server 11 (24), and combines the desired tasks to create and register the job flow (25). The registered job flow is managed on management server 11.

Once the job flow registration is complete, it is possible to execute the job flow from a print processing apparatus managed by management server 11. For example, print processing apparatus A16 can query the job flow list managed on management server 11 (26). A user 20 who wants to execute a job flow selects the desired job flow from print processing apparatus B17 and executes it (27). Upon receipt of the job flow execution request, management server 11 sends a task execution request to the task processing apparatus capable of executing the tasks within the job flow (28), and executes the selected job flow. Information such as that designates which task processing apparatus to execute which task within a job flow, and the task name, are managed in task list database 13 as task definition information, which is described in detail in FIG. 3.

Carrying out registration of applications without going through client PC 12, on the other hand, is as shown in FIG. 2B. The difference between this and FIG. 2A is the fact that management server 11 gets the newly registered application's (application B15) task interface information directly from application B15 (29). Consequently, neither the registration of task interface information from application B15 to client PC 12 (21), nor the application registration from client PC 12 to management server 11 (22), are in FIG. 2B. The rest of the operation flow is as per FIG. 2A.

Task Definition Information

FIG. 3 describes task definition information derived when registering task information with task list database 13 (23). Task definition information includes task name 31, task processing apparatus 32, Property information 33, input data 34, and output data 35. Task name 31 gives the task name of the task in question. Task processing apparatus 32 refers to the task processing apparatuses capable of executing the task in question. Property information 33 gives property information required when executing the task in question. Input data 34 gives input data required when executing the task in question. Output data 35 gives output data outputted by execution of the task in question. Each of input data 34 and output data 35 can be defined to include a plurality of data types. Note that description format of the task definition information is not necessarily restricted to those given in FIG. 3.

Job Flow Definition Information

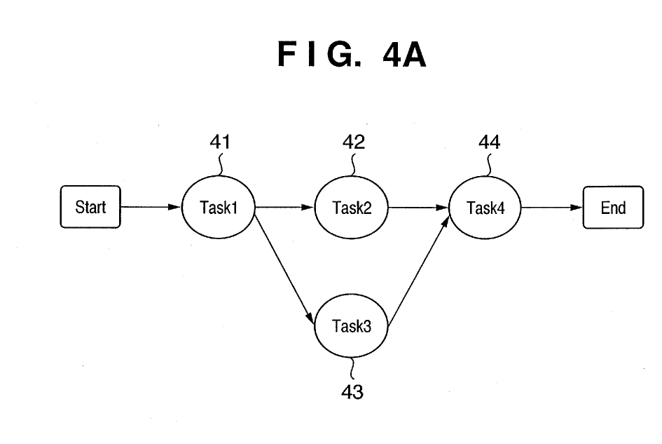

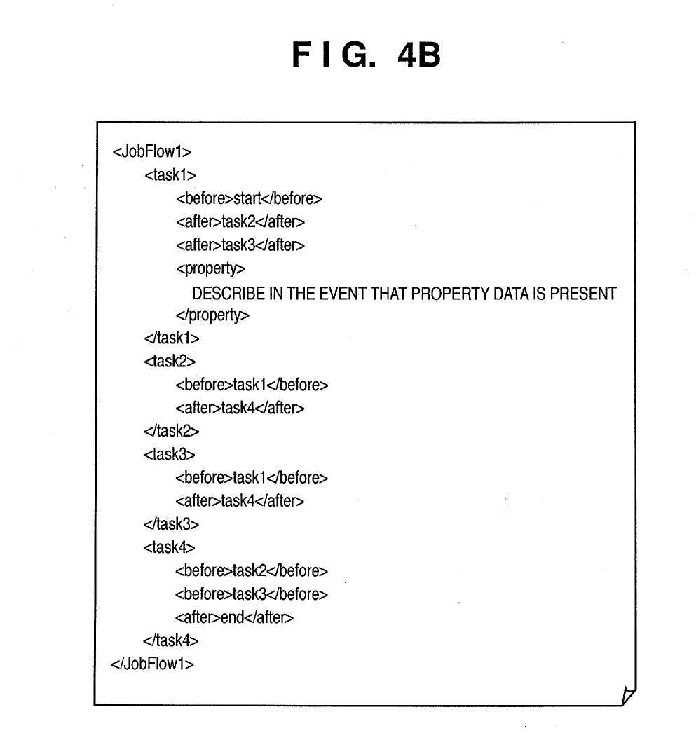

This section describes definition information of a job flow generated by client PC 12 and registered on management server 11 (job flow definition information). FIGS. 4A and 4B describe job flow definition information according to the embodiment. In the embodiment, job flow definition information is registered on management server 11 as a file. Accordingly, job flow definition information may be referred to as a job flow definition file in some instances.

FIG. 4A depicts a typical form of job flow definition information in order to describe job flow definition information according to the embodiment. In the example shown in FIG. 4A, the job flow executes task 41 (Task1), then executes task 42 (Task2) and task 43 (Task3) in parallel, then executes task 44 (Task4), and ends.

FIG. 4B depicts the job flow definition information outlined in FIG. 4A in XML format. In the embodiment, “task” tags are provided for in XML to define task execution sequence, with a task name tagged as “before” if it executes prior to a given task, and “after” if it executes after a given task. In the event that information concerning task properties is defined within task definition information (the property information given in FIG. 3), this information is described within the “property” tag. The job flow definition information is completed by describing the definitions for all tasks defined in the job flow. Descriptions of job flow definition information are not restricted to XML formatting of the type described here; rather, any manner capable of clarifying task sequence relations will be sufficient.

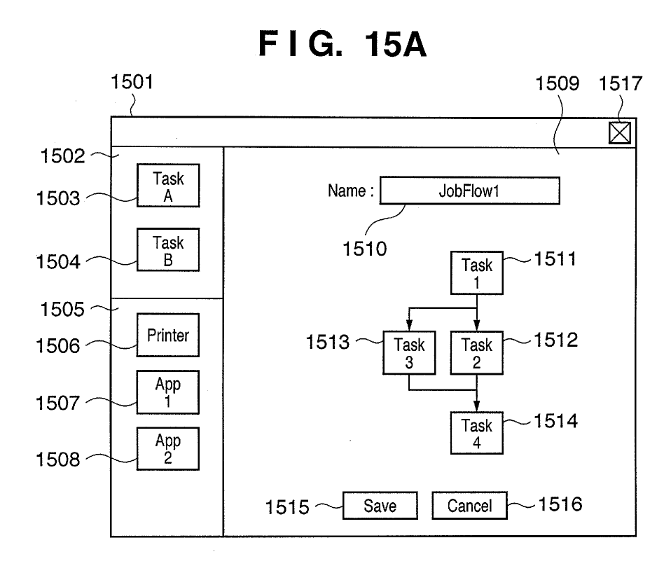

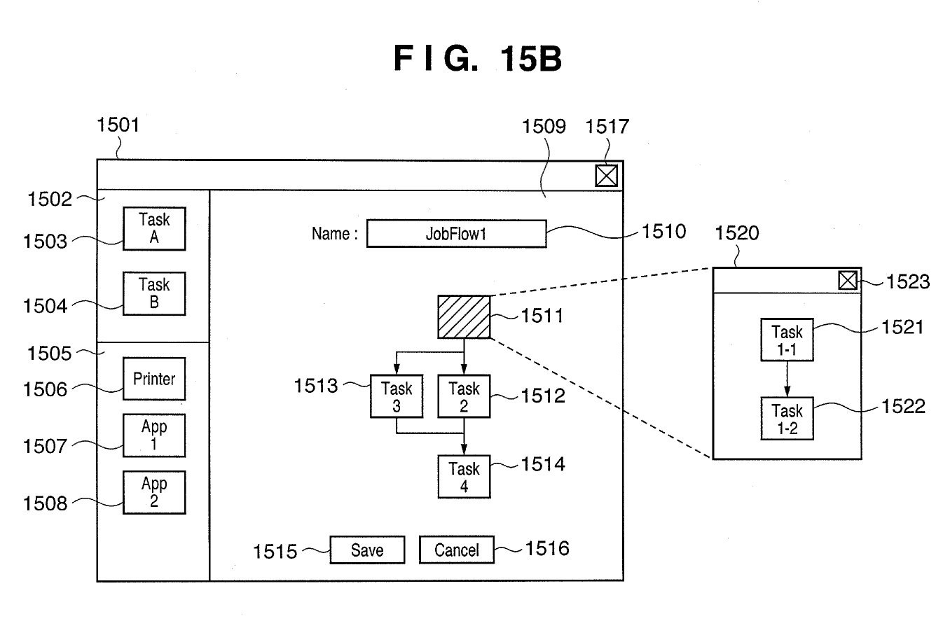

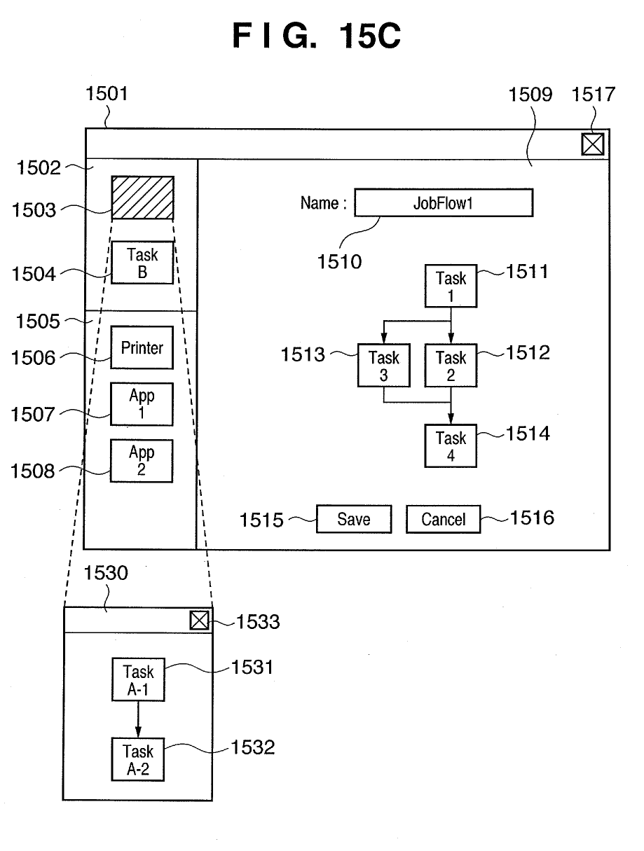

A user may use a job flow creation editor to create job flow definition information like the foregoing. The job flow creation editor is, for example, launched on client PC 12 and designates tasks stored in task list database 13 with icons. The user uses the job flow creation editor to create a job flow by arranging icons corresponding to desired tasks in a manner such as that given in FIG. 4A. When a job flow is created such as in FIG. 4A, the job flow creation editor generates fob flow definition information such as that depicted in FIG. 4B, and registers it for future use with management server 11. The job flow creation editor is described in FIGS. 15A-C, following.

Partitioning of Tasks Coincident with Application Updates

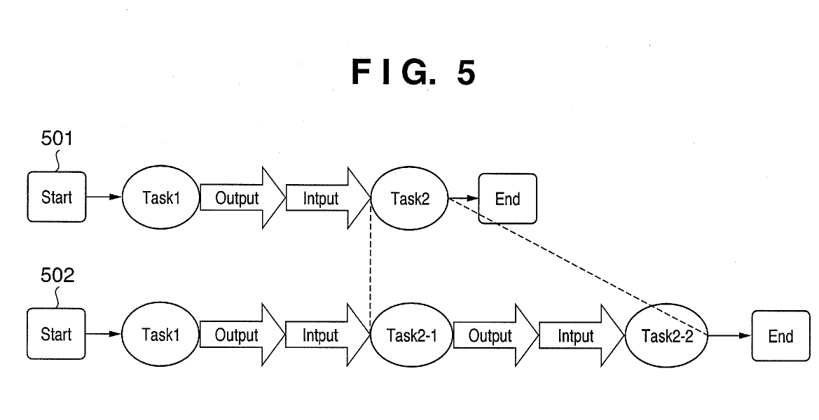

FIG. 5 depicts the changes in a job flow definition within the embodiment, before and after an application upgrade. In FIG. 5, partitioning of a task due to an application update is shown. In FIG. 5, reference numeral 501 denotes typical job flow definition information prior to an application update, and reference numeral 502 denotes typical job flow definition information following an application update. In FIG. 5, the update has subdivided Task2 into Task2-1 and Task2-2. It is shown that Task2 in job flow 501 is the same as the union.of Task2-1 and Task2-2 in job flow 502.

Automated Operation flow Updates Coincident with Application Updates

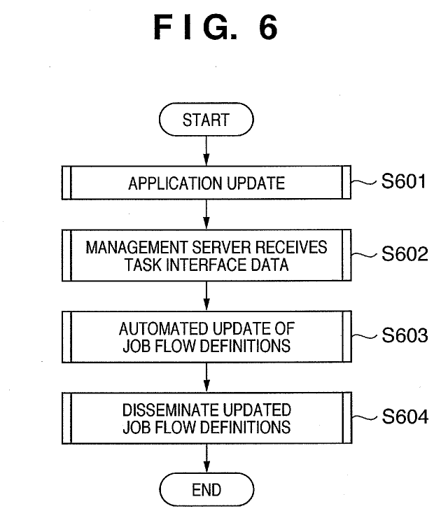

FIG. 6 is a flowchart describing processing of application updates within the context of task cooperation processing according to the embodiment.

Step S601 depicts the updating of application A14 or application B15 from FIG. 1. The updated application sends post-update task interface information to management server 11. In Step S602, management server 11 receives the sent task interface information. In Step S603, management server 11 automatically updates job flow definition information according to the task interface information received in Step S602. In Step S604, management server 11 saves the job flow definition information that was updated in Step S603, and updates task list database 13 according to the task interface information received in Step S602.

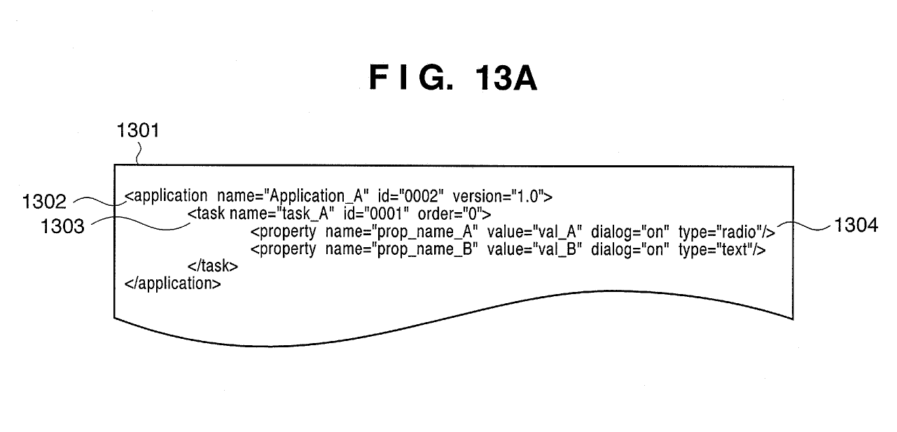

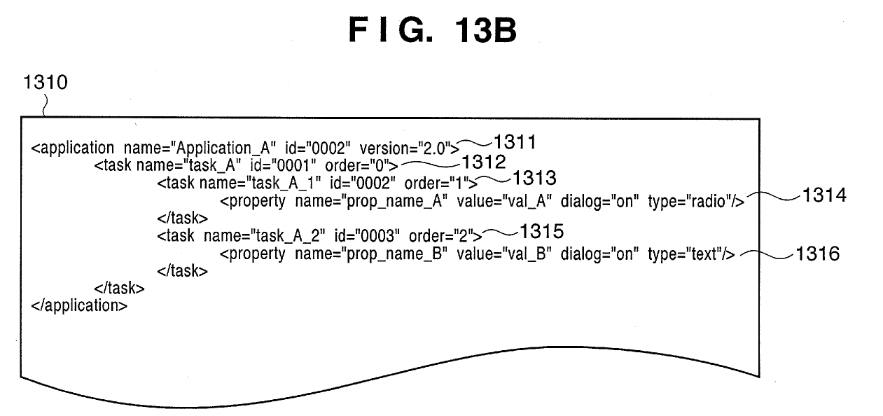

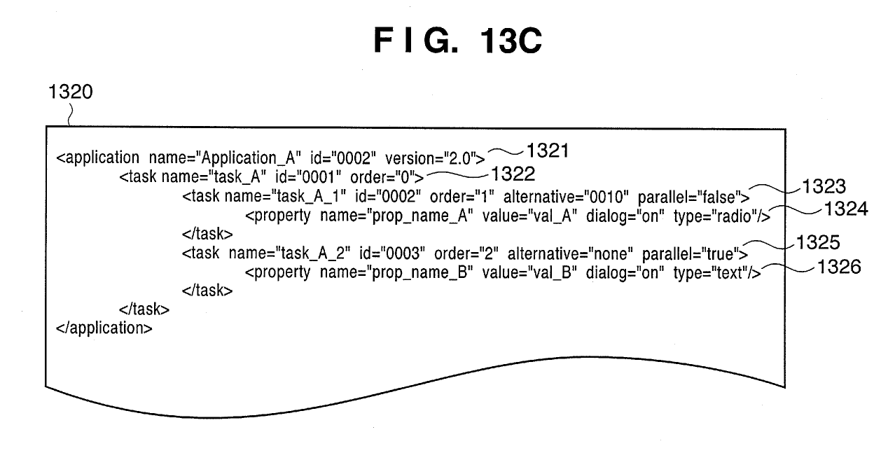

FIG. 13A depicts an example of task interface information possessed by the application according to the embodiment. While FIG. 13A depicts task interface information version 1.0 with regard to application A14, application B15 possesses similar task interface information as well.

Reference numeral 1301 denotes the task interface information version 1.0 for application A14 from FIG. 1. Description 1302 describes the application name, identifier (id), and version number (version) belonging to application A14. In the example description 1302, application A14's application name is given as “Application_A”, its id as 0002, and its version as 1.0. Description 1303 depicts the name of the task defined for application A14 (task_name), the task's identifier (id), and a number signifying its place in the order of task execution (order). In description 1303, the task_name is task_A, the id is 0001, and the order is 0. Furthermore, description 1304 depicts property information belonging to the task (task_A) depicted in description 1303. It is permissible for different tasks to possess multiple property information, depending on the task in question. “Order” dictates the sequence in which partitioned tasks are processed. For example, if Task2 were subdivided in a manner such as that shown in FIG. 5, order values would be assigned to describe an order that would made the order of processing proceed from Task2-1 to Task2-2 (see FIG. 13B)

The preceding task interface information descriptions are not restricted to XML, provided they allow respective applications to be able to manage their respective task names, ids, and order values internally to themselves.

FIG. 13B depicts an example description of the task interface information 1310 depicted in FIG. 13A, following task interface information updating. Description 1311 corresponds to description 1302 in FIG. 13A, depicting Application_A, version 2.0. Description 1312 corresponds to description 1303 in FIG. 13A, in the pre-update task interface information. In the post-update task interface information 1310, description 1312 (Task_A) exists as a parent node in order to maintain compatibility with pre-update Task_A. Description 1313 and description 1315 depict Task_A_1 and Task_A_2 existing as child nodes of Task_A that was described in description 1312. The depictions of task_name, id, and order value in descriptions 1313 and 1315 are similar to those given in description 1303.

Descriptions 1314 and 1316 represent the property information in the respective tasks represented by descriptions 1313 and 1315. It is permissible for different tasks to possess multiple property information, depending on the task in question. These task interface information descriptions are not restricted to XML, provided they allow respective applications to be able to manage their respective task names, ids, and order values internally to themselves.

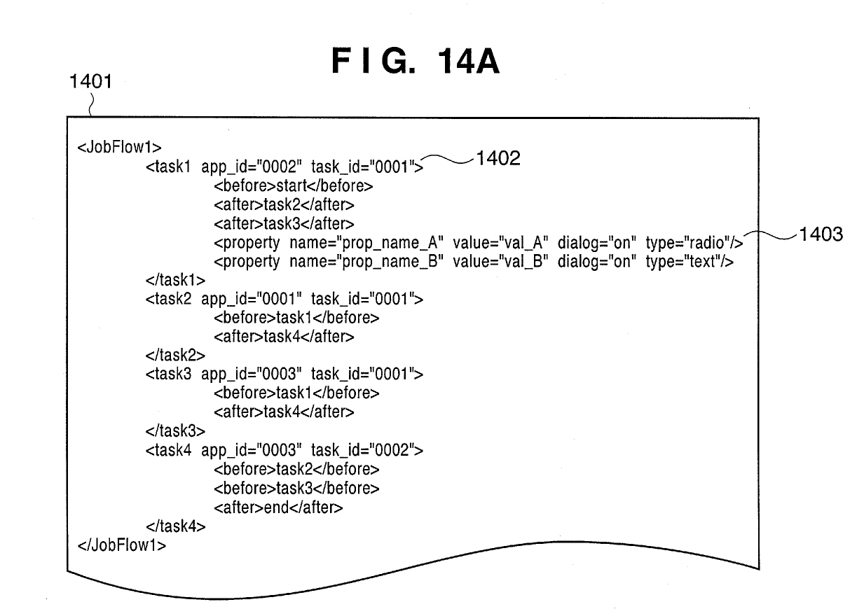

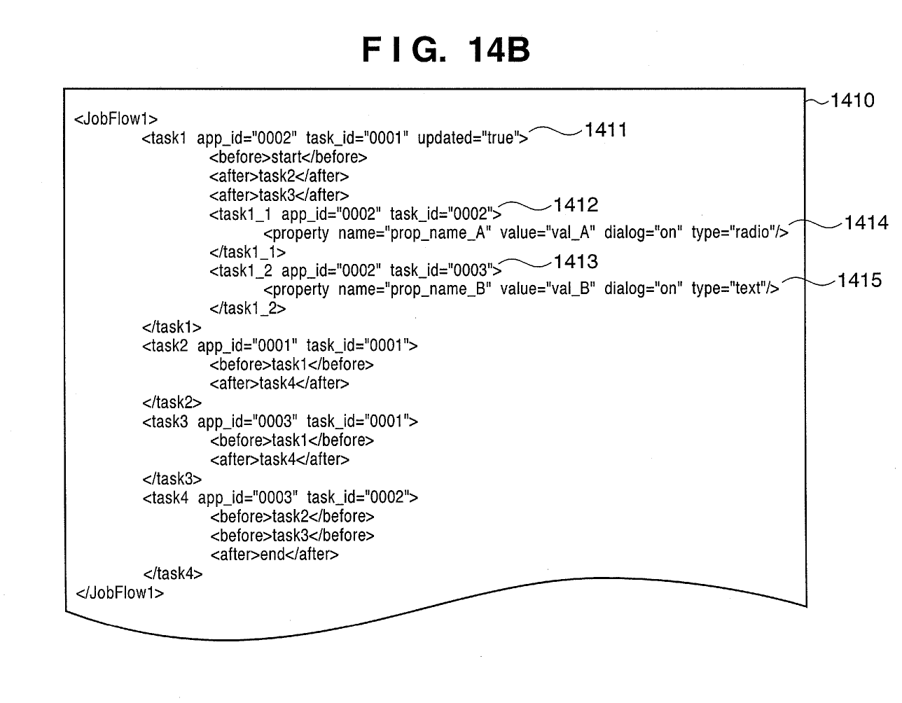

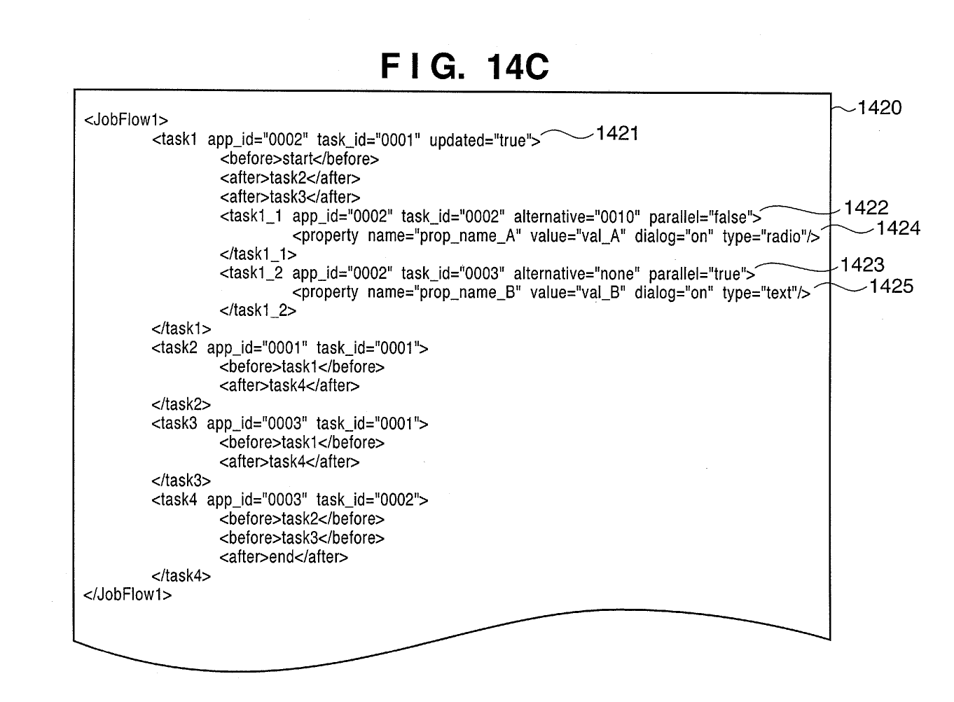

FIG. 14A depicts an example representation of job flow definition information according to the embodiment. Job flow definition information 1401 depicts an example of job flow definition information managed on management server 11. The task connection relationships, according to the “before” tags and “after” tags, are as per the descriptions previously given in FIG. 4B.

Description 1402 depicts task information that constitutes job flow definition information. It comprises an application identifier (app_id), and a task identifier that is defined in the application (task_id). Description 1402 describes the task with id 0001 in the application with id 0002 (task_A in FIGS. 13A and 13B) as task1. It is also permissible to describe property information in the task description, such as that depicted in description 1403. Task information in job flow definition information 1401 beginning with description 1402 defines the task represented by description 1303 in FIG. 13A. These descriptions of job flow definition information are not restricted to XML, provided they allow management of task precedence relations, applications, and task ids.

FIG. 14B depicts job flow definition information after the job flow definition information depicted in FIG. 14A is updated. That is, FIG. 14B depicts an example of job flow definition information derived by management server 11 automatically updating the job flow definition information in FIG. 14A.

Description 1411 depicts task information constituting job flow definition information. Corresponding to description 1402, it includes application identifiers and identifiers of tasks defined in applications. Description 1411 describes an Update Flag that indicates that the corresponding application has been updated (updated=“true”). In FIG. 14S, description 1411 exists as a parent node in order to maintain compatibility with the job flow definition information depicted in FIG. 14A. Tasks depicted in descriptions 1412 and 1413 are depicted as child nodes of the task depicted in description 1411 (the parent node), thus it is indicated that the task depicted in description 1411 comprises tasks depicted in descriptions 1412 and 1413. The job flow definition information update is carried out in accordance with the post-update task interface information depicted in FIG. 13B. In such manner, the job flow definition information is updated by relating description 1411, which depicts the pre-update task, and adding the registrations of descriptions 1412 and 1413 for the post-update task structures, as depicted in FIG. 13B. Property information described in descriptions 1414 and 1415 may also belong to tasks in descriptions 1412 and 1413. It is permissible for different tasks to possess multiple property information, depending on the task in question.

The preceding descriptions of job flow definition information according to the embodiment are not restricted to XML, provided they allow management of task precedence relations, applications, and task ids.

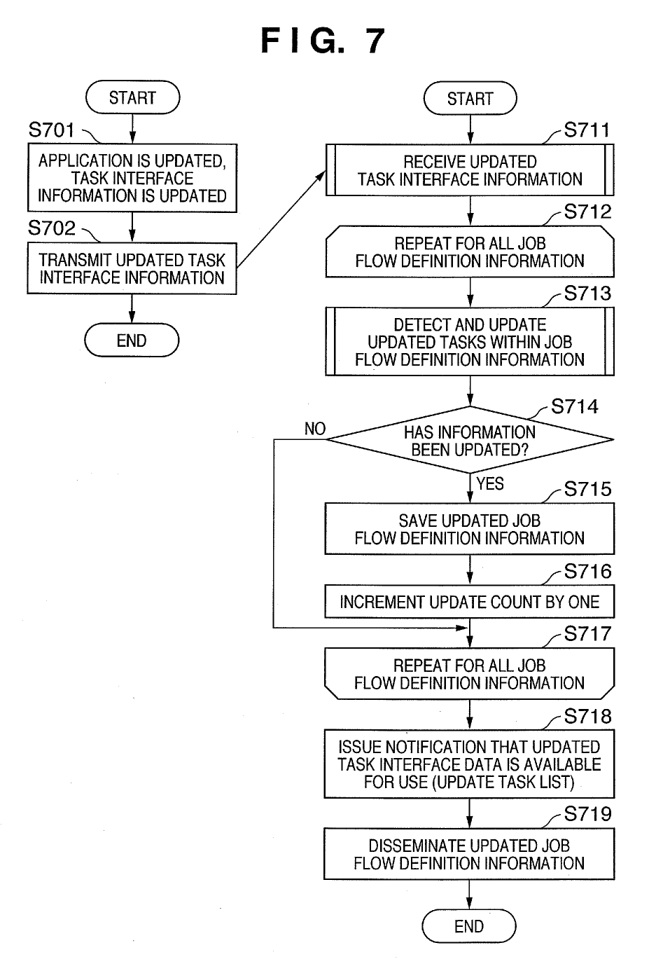

FIG. 7 is a flowchart, depicting automated update processing of job flow definition information according to the embodiment.

When an application within a task processing apparatus, such as application A14 in FIG. 1, is updated, and task interface information is updated (Step S701), the post-update task interface information is transmitted to management server 11 (Step S702). The processes in Steps S701 and S702 correspond to Step S601.

In Step S711, management server 11 receives the post-update task interface information transmitted in Step S702, for example, the task interface information depicted in FIG. 13B. Having received the post-update task interface information, management server 11 executes the processes beginning with Step S712. Step S711 corresponds to Step S602 in FIG. 6, Steps S712-S718 with Step S603 in FIG. 6, and Step S719 with Step S604 in FIG. 6.

In Steps S712-S717, management server 11 executes processes in Steps S713-S716 on all job flow definition information that the server manages. That is, S712 and S717 indicate that the processes in Steps S713-S716 repeat as many times as there are job flow definition information managed by management server 11.

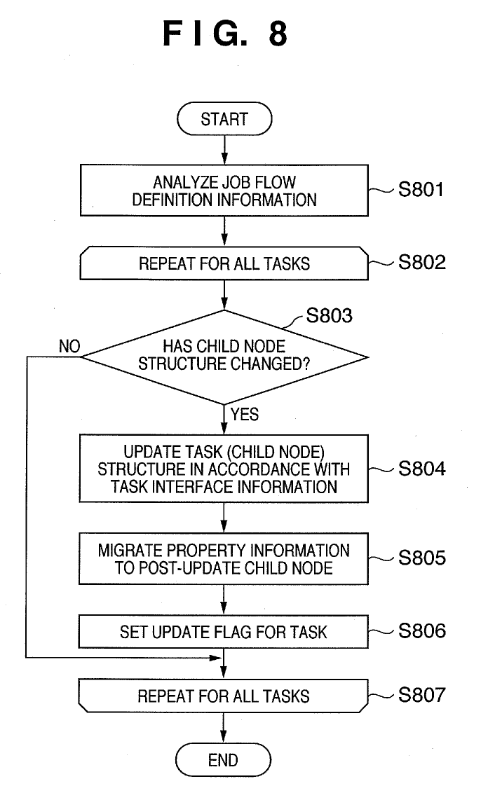

In Step S713, management server 11 compares job flow definition information in question with task interface information received in Step S711, and detects an updated task. In the event that an updated task is detected, the detected task is automatically updated, in accordance with task interface information received in Step S711. Processes in Step S713 will be described in FIG. 8, following. In the event that job flow definition information is updated in the processes of Step S713, the sequence proceeds from Step S714 to Step S715, where the relevant updated job flow definition information is saved.

Suppose, for example, that post-update task interface information depicted in FIG. 13B is received in Step S711, and the job flow definition information being examined in Step S713 is that shown in FIG. 14A. In this instance, “task1”, in the Job flow definition information in FIG. 14A, corresponds to “taskA” of task interface information in FIG. 13B, and a comparison of the two reveals that the task has been updated. The correspondence between task1 and taskA can be found by application IDs and task IDs (in both FIGS. 13B and 14A, application IDs (App_id)=0002, and task IDs (task_id)=0001, in both instances) In this instance, information on task1 in job flow definition information is updated in Step S713, and the updated job flow definition information is saved (S714, S715).

Job flow definition information is automatically updated as per the foregoing, and the number of updated job flow definition information is incremented by one in Step S716.

Once the processes in Steps S712-S717 are finished, processing proceeds to Step S718. In Step S718, management server 11 updates task list database 13, and notifies all task processing apparatuses within the task cooperation system that the new task is available for use. In Step S719, management server 11 saves job flow definition information updated by the processes in Steps S712-S717 in externally usable form, and delivers this job flow definition information to all task processing apparatuses within the task cooperation system. In the event that there are no updated tasks, that is, that the update count of updates in Step S716 is zero, neither the notification in Step S718, nor the delivery in Step S719, will take place.

FIG. 8 is a flowchart depicting in detail the process of automated updating of job flow definition information by management server 11. The flowchart in FIG. 8 is a detailed depiction of the process in Step S713 of FIG. 7.

In Step S801, management server 11 analyzes job flow definition information. In the subsequent Steps S802-S807, management server 11 executes the processes given in Steps S803-S806 on all tasks contained in the job flow definition information.

Beginning in Step S803, management server 11 compares tasks within the job flow definition information with tasks defined by updated task interface information (the task interface information received in Step S711). In this comparison, a determination is made as to whether the task being examined corresponds to a new version task, and whether there are changes in child node composition between the task being examined and the new version task. For example, “taskA” of task interface information in FIG. 13B and “task1” in the job flow definition information in FIG. 14A are corresponding tasks, because they both have id=0002 and application id=0001. Post-update taskA in FIG. 13B has two child nodes, task_A_1 and task_A_2, whereas job flow definition information in FIG. 14A has no child nodes. In other words, there are changes in child nodes. In the event that child node compositions have changed, processing proceed to Step S804.

In Step S804, management server 11 updates relevant tasks within the job flow definition information, according to updated task child nodes. In the foregoing example of FIGS. 14A and 13B, the child nodes in FIG. 13B, task_A_1 and task_A_2, have been added to task1 in FIG. 14A. In Step S805, management server 11 migrates property information to child nodes added in Step S804. That is, property information appended to each of the subdivided tasks is described in the updated task interface information. Then, in Step S806, an update flag is set for the task that was updated in Steps S804 and S805. To be more specific, an update flag (update=“true”) is set for the parent node task that has had updates to child nodes, as indicated by description 1411 in FIG. 14B.

When the preceding processes have been executed on all tasks contained within the job flow definition information, processing exits the loop of Steps S802-S807, and proceeds with Step S714 of FIG. 7.

Whereas in Step S803, foregoing, changes to child node composition were depicted as being a change from a state of zero child nodes to a state of two child nodes (FIGS. 13B and 14A), this does not constitute a limitation in this regard. It goes without saying that, for example, it would be possible to detect such changes as the number of child nodes going from two to three.

As described in the foregoing, in the event that task interface information in an application, such as shown in FIG. 13A, is updated such as shown in FIG. 13B, job flow definition information shown in FIG. 14A is updated such as shown in FIG. 14B. In this manner, usability is improved through automated updating, while maintaining compatibility, even in the event that application updates result in functions being subdivided.

Executing Updated Job Flow

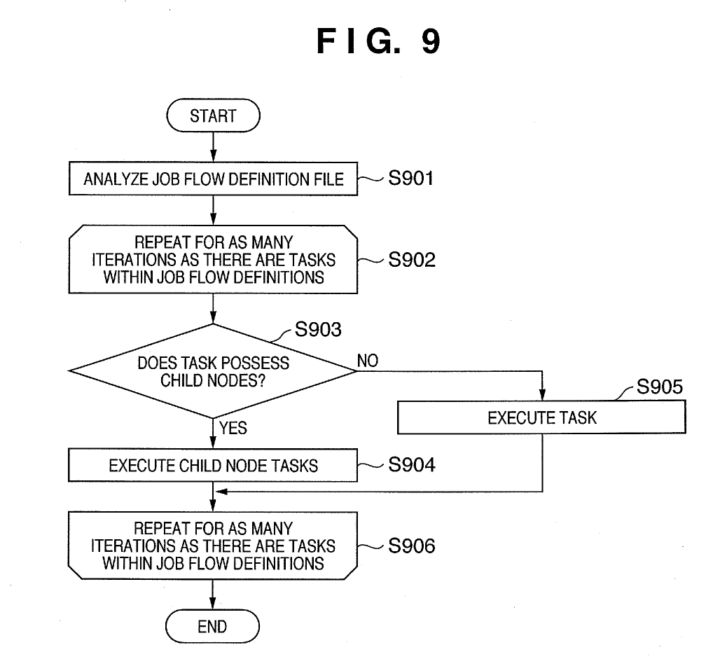

FIG. 9 is a flowchart depicting processes that execute tasks according to new versions of job flow definition information under the embodiment. Following is a description of a sample execution of job flow definition information depicted in FIG. 14B.

In Step S901, management server 11 analyzes job flow definition information. At this time, task execution sequence is determined by “before” tags and “after” tags. Management server 11 repeats the processes in Steps S902-S906 as many times as there are tasks within the job flow definition information analyzed in Step S901. However, tasks are selected in the execution sequence determined in Step S901, and processes executed in Step S903-S905. First, in Step S903, management server 11 determines whether a task within the job flow definition information has child node tasks or not (that is, whether a task has been subdivided or not). In the event that a child node task is present, processing proceeds to Step S904, where a command is issued to either the application or the print processing apparatus that executes a task to execute the child node task. Execution sequence for child nodes follows the sequence depicted in FIG. 14B. This sequence follows sequence information (order values) depicted in FIG. 13B. That is, in the case of FIG. 14B, executing task1 will involve executing child nodes task1_1 and task1_2, in that order.

Designating of child node execution sequences is not restricted to the foregoing methods, however. For example, it would also be permissible to use “before” and “after” tags, as described in FIG. 4B and elsewhere, to designate child node execution sequences as well. Using these tags to designate execution sequences allows designation of child node execution sequences, including parallel processing such as that depicted in FIG. 4A.

Parallel Processing Coincident with Application Updates

FIG. 13C is an example of a representation of task interface information in an application according to the embodiment. The task interface information depicted in FIG. 13C shows a plurality of additions of information to task interface information shown in FIG. 13B.

In task interface information 1320 depicted in FIG. 13C, description 1321 represents application name, identifier, and version number belonging to application A 14. Description 1322 depicts a task name, an identifier, and order value defined in application A14. In this instance, description 1322 exists as a parent node, in order to maintain compatibility. Descriptions 1323 and 1325 depict tasks that exist as child nodes of the task in description 1322 (parent node). These descriptions show that task 1322 comprises task 1323 and task 1325.

Description 1323 possesses an alternative identifier (alternative), and a flag that signals whether a task can be processed in parallel or not (parallel), in addition to the task name, identifier, and order value that are similar to description 1313 in FIG. 14B. This information enables alternative processing and parallel processing of tasks when job flow definition information is created. Descriptions 1324 and 1326 describe property information of tasks in descriptions 1323 and 1325. It is permissible for different tasks to possess multiple property information, depending on the task in question. Descriptions of task interface information are not restricted to XML formatting of the type described here; rather, any manner capable of managing task names, identifiers, order values, alternative identifiers, and parallel processing flags on a per application basis will be sufficient.

FIG. 14C depicts an example of job flow definition information updated in accordance with task interface information in FIG. 13C within the embodiment. Job flow definition information 1420 is updated from job flow definition information 1401 by management server 11, as depicted in FIG. 14A, in accordance with task interface information as depicted in FIG. 13C, notified by application updates.

Description 1421 depicts a task that constitutes job flow definition information, and, similar to description 1411, comprises an application identifier, a task identifier defined within the application, and an update flag. In this instance, the task displayed by description 1421 exists as a parent node to maintain compatibility. Tasks depicted in descriptions 1422 and 1423 are represented as child nodes of the task represented by the description 1421 (parent nodes). That is, it is indicated that the task represented by the description 1421 comprises tasks represented in descriptions 1422 and 1423.

In job flow definition information 1420 in FIG. 14C, descriptions of child node tasks possess alternative identifiers and parallel processing flags, in addition to the application identifiers and task identifiers defined within applications. It differs from descriptions 1412 and 1413 of FIG. 14B, on this point. As with job flow definition information 1410 of FIG. 14B, tasks depicted in descriptions 1422 and 1423 may possess property information respectively, as per descriptions 1424 and 1425. It is permissible for different tasks to possess multiple property information, depending on the task in question. Job flow definition information descriptions are not restricted to XML formatting of the type described here; rather, any manner capable of managing task sequence relations, task identifiers, alternative identifiers, and parallel processing flags will be sufficient.

Alternative Processing

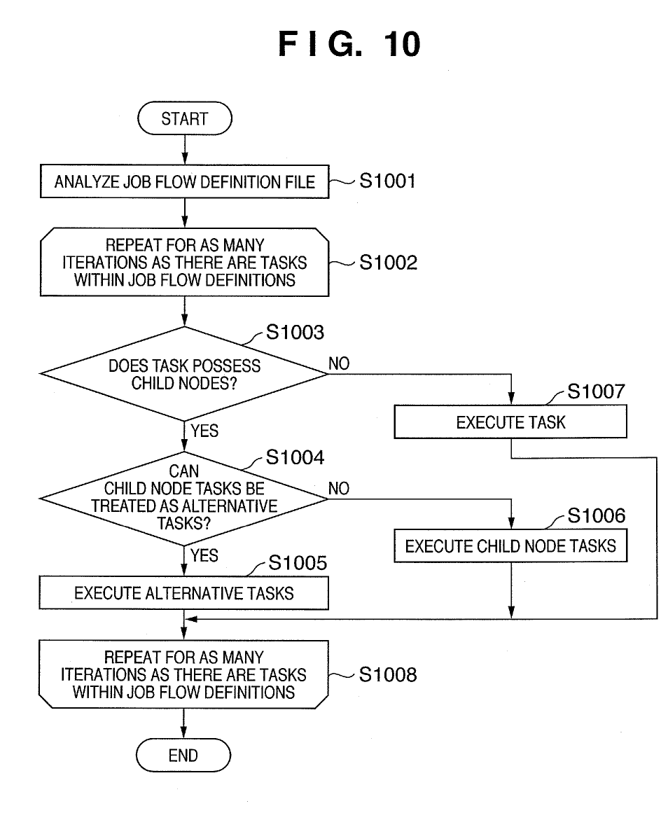

FIG. 10 depicts a flowchart executing an alternative task according to a new version of job flow definition information according to the embodiment. For example, in the event that a task that is executed by software running on a personal computer or other sort of general purpose computer becomes capable of running on dedicated hardware such as a multi function peripheral owing to an upgrade, there exists an alternative task for the task in question. In the event that such an alternative task exists as a consequence of an upgrade, it is identified as “alternative=0010”, as depicted in FIG. 14C, description 1422. In the example in FIG. 14C, it is shown that two child nodes exist for the pre-existing task1, that is, it is subdivided into task1-1 and task1_2, and that an alternative task exists for task1_1. Also, the “0010” in “alternative=0010” shows that a task with “id=0010” is an alternative task. If an application ID is designated in “alternative”, it becomes possible to designate an alternative task across applications. That is, an “id” designated by “alternative” exclusively identifies a task throughout a system, and a predetermined task of a predetermined multi function peripheral is uniquely designated as “alternative”.

In Step S1001, management server 11 analyzes job flow definition information to be executed. Processes in Step S1002-S1008 repeat as many times as there are tasks within the job flow definition information analyzed in Step S1001. In Step S1003, management server 11 determines whether a task within the job flow definition information has child node tasks or not. In the event that it is determined that a task does possess a child node, processing proceeds to Step S1004, and management server 11 determines whether the child node task is capable of being an alternative task or not. In the event that it is determined that a child node task is capable of being an alternative task, processing proceeds to Step S1005. In Step S1005, management server 11 issues a command to an application or a print processing apparatus executing the task to execute the now-alternative child node task.

If, on the other hand, it is determined in Step S1004 that a child node task is not capable of being an alternative task, processing proceeds to Step S1006. In Step S1006, management server 11 issues a command to an application or a print processing apparatus executing the task to execute the child node task in question. In the event that it is determined that no child nodes exist for a task being examined in Step S1003, processing proceeds to Step S1007. In Step S1007, management server 11 issues a command to an application or a print processing apparatus executing the task to execute the task in question.

Parallel Processing

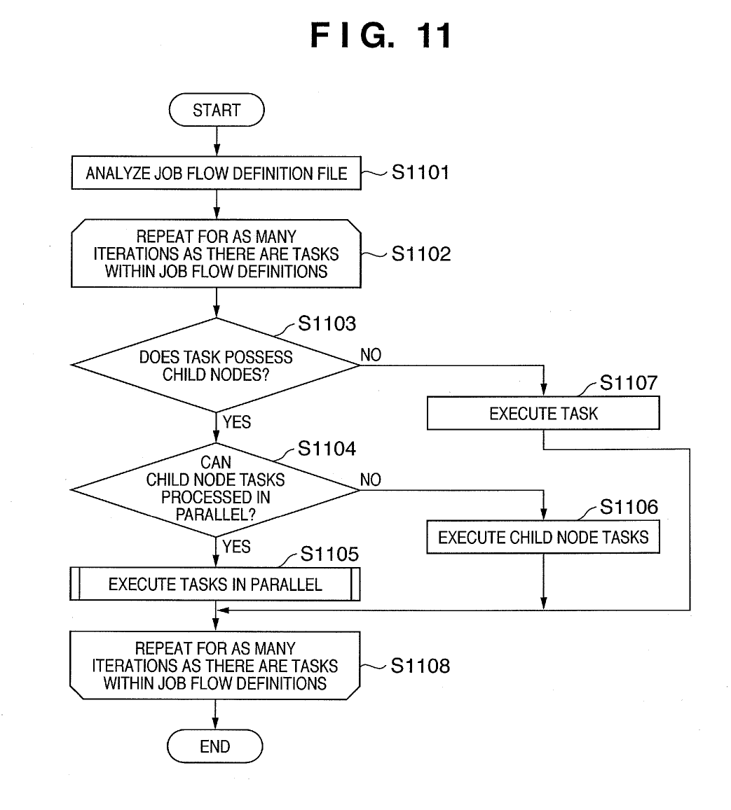

FIG. 11 is a flowchart depicting processes executing tasks in parallel, according to a new version of job flow definition information according to the embodiment. If a given task is made capable of executing in parallel on a plurality of task processing apparatuses, i.e., personal computer, multi function peripheral, or the like, it becomes possible to reduce time taken to execute the task, even for tasks that demand large amounts of processing. For example, processing time for processes such as compressing a large graphics file or the like can be reduced by processing the graphics file with a plurality of tasks (task processing apparatuses) in parallel. Executing a task on a plurality of task processing apparatuses in this manner is referred to as “parallel processing.” For example, there are instances wherein an upgrade may support parallel processing through subdividing of a task. In the event that an upgrade enables parallel processing, the fact that parallel processing is supported is made clear by “parallel=true”, as depicted in FIG. 14C, description 1423.

In Step S1101, management server 11 analyzes job flow definition information. Processes in Steps S1102-S1108 repeat as many times as there are tasks within the job flow definition information deployed in Step S1101. In Step S1103, management server 11 determines whether a task within the job flow definition information possesses a child node task or not. In the event that it is determined in Step S1103 that a child node task is possessed, processing proceeds to Step S1104. In Step S1104, management server 11 determines whether the child node task supports parallel processing or not. In the event that it is determined that the child node task supports parallel processing, processing proceeds to Step S1105. In Step S1105, management server 11 queries task list database 13 and issues a command to applications or print processing apparatuses executing the task to execute the parallel processing child node task. It, on the other hand, it is determined that the child node task does not supports parallel processing, processing proceeds to Step S1106. In Step S1006, management server 11 issues a command to an application or a print processing apparatus executing the task to execute the child node task in question. In the event that it is determined in Step S1103 that no child nodes are possessed, management server 11 issues a command to an application or a print processing apparatus executing the task to execute the task in question, in step S1107.

As described in the foregoing, when application task interface information in FIG. 13A is updated to task interface information in FIG. 13C, job flow definition information in FIG. 14A is updated to a new version of job flow definition information in FIG. 14C. In this manner, usability is improved through automated updating, while maintaining compatibility, even in the event that application updates result in functions being subdivided.

Execution User Interface

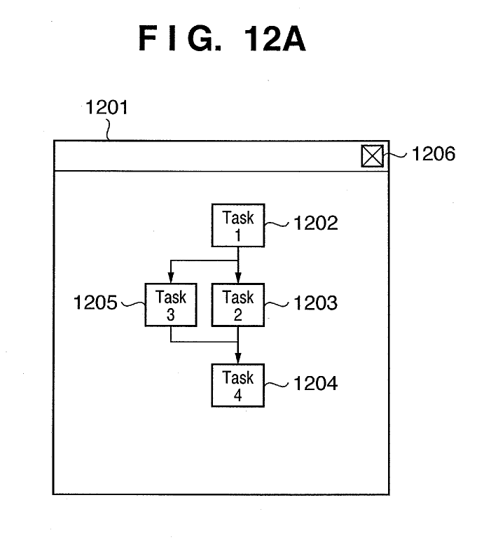

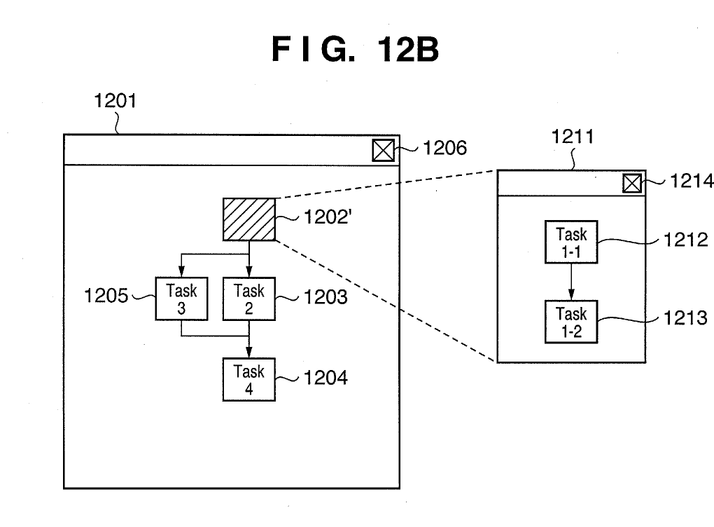

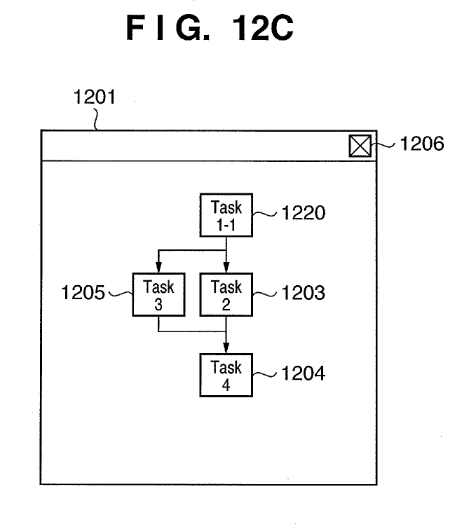

FIG. 12A depicts an example of a user interface (UI) when a job flow is being executed, according to the embodiment.

Job flow process window 1201 is displayed by an apparatus, such as print processing apparatus A16 or print processing apparatus B17, that has received directions for job flow execution. This job flow process window 1201 shows task icons 1202-1205, corresponding to Task1-Task4 that are tasks within print processing apparatus job flow definition information, according to job flow. At the same time, a task being currently processed is shown as capable of identification. Button 1206 provides the feature of closing job flow process window 1201.

FIG. 12B depicts an example of a user interface (UI) when a job flow is being executed after automated updating of job flow definition information, according to the embodiment.

Job flow process window 1201 shows task icons 1202′, and 1203-1205, corresponding to tasks within print processing apparatus job flow definition information, for either print processing apparatus 16 or 17. This figure shows tasks being currently processed as capable of being distinguished, as with FIG. 12A. Task icon 1202′, however, shows that it is possible to distinguish that it is possible to trace a task layer. For example, as described in foregoing, when job flow definition information is updated from FIG. 14A to FIG. 14B, updated task (Task1) will have a child node task. Therefore, in job flow process window 1201, task icon 1202′, which corresponds to the updated task (Task1), signals that it is capable of tracing the task layer by such methods as blinking or changing color. Pressing task icon 1202′ opens sub-window 1211, notifying, using task icon 1212 and task icon 1213, that the task (Tasks) comprises Task1-1 and Task1-2. Button 1214 provides the function of closing sub-window 1211. In the event that execution takes place following automated updating of job flow definition information, the above described functions allow showing layers of tasks that have been subdivided through the relevant automated updating, thus improving usability.

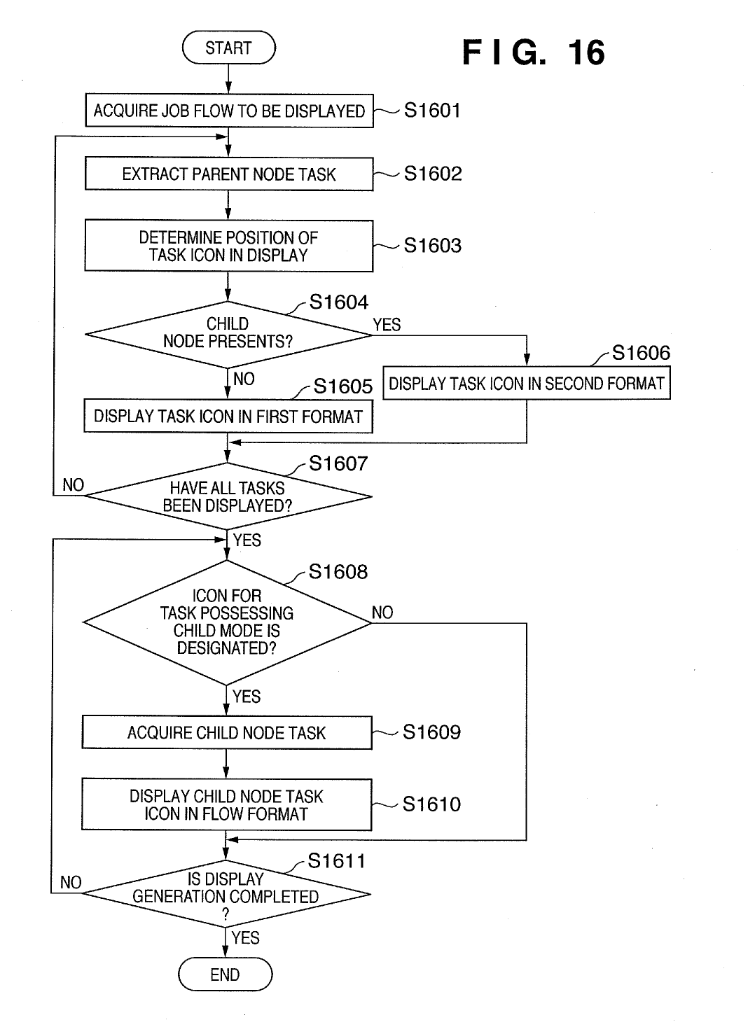

FIG. 16 is a flowchart describing a sequence of processes for achieving the display shown in FIG. 12B. The processes shown in FIG. 16 are executed by an apparatus that designates and executes job flow, print processing apparatus A16 or print processing apparatus B17 in this example. In Step S1601, job flow to be displayed in a display device (not shown) with which a print processing apparatus is equipped, that is, job flow that is directed for execution, or has been directed for execution, is acquired. Job flow possesses a data composition depicted in FIGS. 14B and C.

In Step S1602, a parent node task is sequentially extracted from job flow, and the display position of the task's icon is decided in Step S1603. In Step S1604, a determination is made whether the parent node task has a child node task or not. In the event that the parent node task does not have a child node task, processing proceeds to Step S1605, displaying a task icon for the relevant parent node in a first format. If, on the other hand, the parent node task does have a child node task, processing proceeds to Step S1606, displaying a task icon for the relevant parent node in a second format. For example, task icons for parent nodes in description 1411 of FIG. 14B, or description 1421 of FIG. 14C, possess child nodes, and therefore, are displayed with icons in the second format. Note that the first display format is a display format that, for example, is of a type used for task icons 1203-1205 in FIG. 12B, and the second display format is a display format that is of a type used for task icon 1202′ in FIG. 12B. This process displays the ability to distinguish between parent node tasks that possess child nodes, and parent node tasks that do not possess child nodes. When the processes (step S1607) are carried out for all parent node tasks in the job flow that are to be displayed, job flow display is carried out such as that in FIG. 12B.

In the job flow display in FIG. 12B, when a designation is given for an icon for a task that possesses a child node (task icon 1202′), processing proceeds from Step S1608 to Step S1609. In Step S1609, the child node task is acquired whose parent node corresponds to the designated task. Then, in Step S1610, the task icon for the child node acquired in Step S1609 is displayed in flow format as depicted in FIG. 12B, sub-window 1211. For example, if designation is given for a task icon corresponding to description 1411 of FIG. 145, task icons corresponding to descriptions 1412 and 1413 are displayed in flow format in Sub-window 1211. Displaying in flow format clarifies child node task execution sequence.

When directions are given for Button 1206, these processes end with Step S1611.

FIG. 12C depicts an example of a user interface (UI) according to the embodiment when job flow definition information is created and executed following updating of task interface information through application updating.

In print processing apparatus A16 or print processing apparatus B17, job flow process window 1201 displays task icons 1220, and 1203-1205, which correspond to tasks in print processing apparatus job flow definition information. Also, this display shows tasks being currently processed as capable of being distinguished. For example, colors of task icons corresponding to tasks whose processes are being executed are changed when displaying them. In such an instance, a task is displayed as being usable following task interface information update, as with a task shown in FIG. 14B, description 1412. When task1-1 finishes executing and task1-2 commences execution, display content of task icon 1220 changes to task1-2. Button 1206 provides the feature of closing job flow process window 1201. This function allows display and execution with new tasks and increased usability when creating and executing new job flow definition information following a task interface information update after an application update.

Job Flow Creation Editor User Interface

FIG. 15A depicts an example of a user interface (UI) for a job flow creation editor for editing job flow definition information according to the embodiment. The job flow creation editor launches on client PC 12.

Job flow creation editor window 1501 comprises task list frame 1502, task cooperation processing system composition frame 1505, and job flow definition frame 1509. Task cooperation processing system composition frame 1505 displays a list, using icons (1506-1508), of task processing apparatuses such as print processing apparatuses, applications, and the like, that are capable of being linked with the task cooperation processing system according to the embodiment. When any of icons 1506-1508 displayed within task cooperation system composition frame 1505 is selected, a list of tasks that the task processing apparatus corresponding to the selected icon can execute is displayed in task list frame 1502.

Box 1510 in Job flow definition frame 1509, displays the name of job flow definition information, and a user may edit the job flow definition information name in box 1510. Job flow definition frame 1509 displays task icons 1511-1514, which represent tasks used in the relevant job flow definition information. When save button 1515 is pressed, the concerned job flow definition information is saved, and when cancel button 1516 is pressed, job flow definition information being edited in job flow definition frame 1509 is disposed of. It is also possible to edit a job flow definition by using drag and drop operations of task icons 1503 and 1504 within task list frame 1502 to job flow definition frame 1509. Button 1517 provides the function of closing Job flow creation editor window 1501.

FIG. 15B depicts a sample display of a Job flow creation editor user interface (UI) following automated updating of a job flow definition. The job flow display depicted in FIG. 15B is achieved through processes similar tothe job flow display processes at job flow execution (the sequence depicted in FIG. 16). However, the job flow to be displayed is the job flow subject to editing. In the event that a task is added to a job flow through editing, the additional task may be processed in a manner similar to Steps S1603-S1606.

The difference between FIG. 15B and FIG. 15A is the fact that task icon 1511, which depicts a task within job flow definition information that has been automatically updated (Task1 in the present example) is capable of showing layers. Pressing task icon 1511 displays sub-window 1520, as shown in FIG. 15B. Sub-window 1520 shows that updated Task1 comprises a plurality of tasks, as displayed in task icons 1521 and 1522 (Task1-1, Task1-2). Button 1523 provides the function of closing Sub-window 1520. The above described feature allows compatibility to be maintained and new tasks to be displayed, thus improving usability, even with automatically updated job flow definition information.

FIG. 15C depicts a sample of a job flow creation editor user interface (UI) when editing job flow definition information, following updating of an application and updating of task interface information.

The difference between FIG. 15C and FIG. 15A is the fact that task icon 1503, which displays a task whose task interface information is updated in task list frame 1502 (“TaskA”.in the present example), is capable of showing layers. Pressing task icon 1503 displays sub-window 1530. This sub-window 1530 shows that TaskA, whose task interface information is updated, has a plurality of tasks which are displayed by task icons 1531 and 1532 (TaskA-1, TaskA-2). It is possible to drag and drop task icons 1531 and 1532 into job flow definition frame 1509 and edit job flow definition information. In this manner, it is possible to define a job flow using a task whose functions have been subdivided by updating, as depicted in FIG. 12C. Button 1533 offers the feature of closing sub-window 1530. This feature allows compatibility to be maintained when editing job flow definition information after updating of task interface information, thus improving usability.

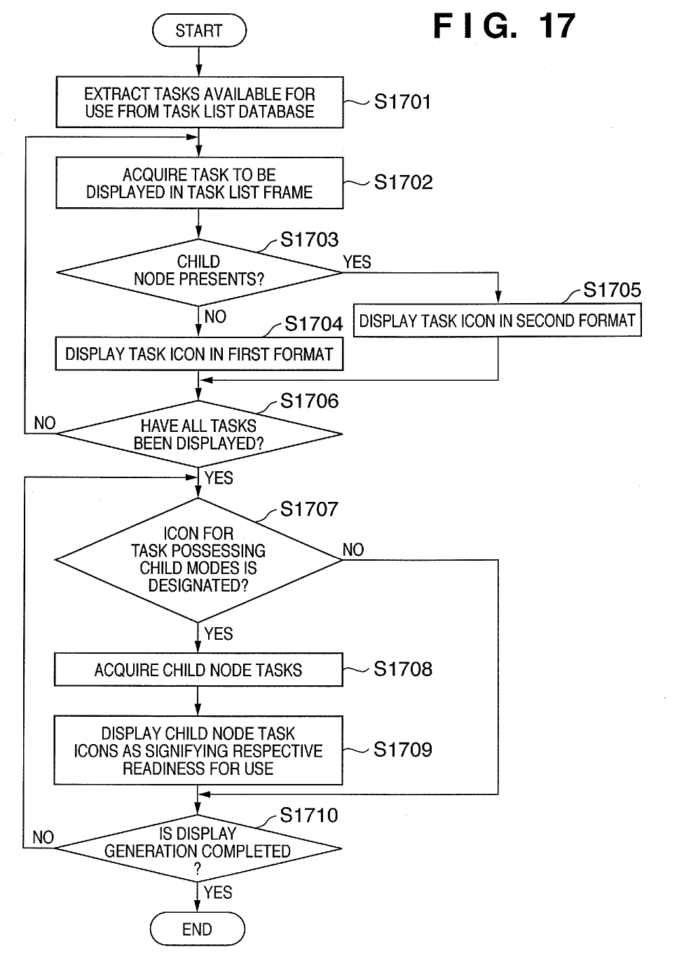

FIG. 17 is a flowchart describing a process sequence on client PC 12 for achieving the display depicted in FIG. 15C. In Step S1701, a task usable for creating or editing of a job flow is acquired from Task List DB 53. Description of acquired tasks is as depicted in FIGS. 13A-13C.

In Step S1702, a task to be displayed in task list frame 1502 is acquired. In the event that the acquired task possesses no child nodes, processing proceeds from Step S1703 to Step S1704, and the task icon of the relevant task is displayed in first format. In the event that the acquired task does possesses a child node, processing proceeds to Step S1705, and the task icon of the relevant task is displayed in second format. For instance, a task in FIG. 13A does not possess a child node, and its task icon is displayed in first format, whereas tasks in FIGS. 13B and 13C do possess child nodes, and their icons are thus displayed in second format. First format refers to a display format such as, for example, that of task icon 1504 in FIG. 15C, and second format refers to a display format such as, for example, that of task icon 1503 in FIG. 15C. By these processes, it is possible to display a parent node task that possesses a child node and a parent node task that does not possess a child node in differentiated manner. When the processes are carried out for all parent node tasks to be displayed in task list frame 1502 (Step S1706), processing proceeds to Step S1707.

When an icon for a task that possesses child nodes (a task icon displayed in second format) is designated, processing proceeds from Step S1707 to Step S1708. In Step S1708, a child node task of the designated task is acquired. Then, Step S1709 presents a task icon for the child node task acquired in Step S1708 as capable of use in creation and editing on a per icon basis. These processes achieve display of sub-window 1530, and presentation of task icons 1531 and 1532.

As described in the preceding, in such events as that wherein applications are updated and functions subdivided in the task cooperation processing system according to the embodiment, job flow is updated automatically. As a result, administrators are spared time and trouble in updating job flows.

The preceding embodiment cites examples of applications running on an information processing apparatus such as a personal computer that links externally to print processing apparatus tasks, including copying, scanning, faxing, storing on hard drives inside print processing apparatuses, e-mail transmission, and the like. In other words, these are examples of print process apparatus tasks and process tasks of applications running on information processing apparatuses that are linked to form job flow. Note, however, that it is not necessary to link print processing apparatuses with information processing apparatuses under the present invention; rather, the present invention may be applied to job flow generation within a standalone print processing apparatus. The present invention may also be applied when process tasks of applications running on either a single information processing apparatus or a plurality of information processing apparatuses are linked to generate job flow.

The object of the present invention can also be achieved by supplying a storage medium (or recording medium) which stores software program codes for implementing the functions of the above-described embodiment to a system or apparatus and causing the computer (or a CPU or MPU) of the system or apparatus to read out and execute the program codes stored in the storage medium.

In this case, the program codes read out from the storage medium implement the functions of the above-described embodiment by themselves, and the storage medium which stores the program codes constitutes the present invention. The functions of the above-described embodiment are implemented not only when the readout program codes are executed by the computer but also when the operating system (OS) running on the computer performs part or all of actual processing on the basis of the instructions of the program codes.

The functions of the above-described embodiment are also implemented when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

The present invention is also achieved when software program codes for implementing the functions of the above-described embodiment are distributed through a network and stored in a storage means such as a hard disk or memory of a system or apparatus or a storage medium such as a CD-RW or CD-R, and the computer (or CPU or MPU) of the system or apparatus reads out and executes the program codes stored in the storage means or storage medium.

As per the foregoing, automated updating of Job flow definition information according to task updates is possible, improving ease of use in task cooperation processing systems.

While the present invention has been described with reference to exemplary embodiments, it is to be understood that the invention is not limited to the disclosed exemplary embodiments. The scope of the following claims to be accorded the broadest interpretation so as to encompass all such modifications and equivalent structures and functions.

This application claims the benefit of Japanese Patent Application No. 2005-321394, filed Nov. 4, 2005, which is hereby incorporated by reference herein in its entirety.

What is claimed is:

1. An information processing method for managing flow information that defines a cooperation processing of a plurality of tasks, the method comprising:
an acquiring step of acquiring update information that depicts a task that is subject to updating and a task structure of the task after updating;
a detecting step of detecting task information corresponding to a task that is subject to updating, indicated by the update information, from registered flow information; and
an updating step of updating the flow information by adding, to the task information detected by the detecting step, information that depicts a task structure after updating that is depicted in the update information.

2. The method according to claim 1, wherein, in the event that the task structure after updating possesses a plurality of tasks, the updating step describes the task corresponding to the task information detected by the detecting step in the flow information as a parent node, and the plurality of tasks that the task structure after updating possesses, as a child node of the parent node.

3. The method according to claim 2, wherein the update information that depicts the task structure after updating possesses information depicting execution sequence of a plurality of tasks contained within the task structure.

4. An information processing method that processes the display of tasks for structuring flow information that defines a cooperation processing of a plurality of tasks, the method comprising:
a determination step of determining, in accordance with task information for a task to be displayed, whether or not the task is being subdivided into a plurality of tasks;
a first displaying step of displaying the task in a first format in the event that it is determined in the determination step that the task is being subdivided, and in a second format that differs from the first format in the event that it is determined in the determination step that the task is not being subdivided; and
a second displaying step of displaying a task as a plurality of subdivided tasks in the event that the task is directed as being displayed in the first format.

5. The method according to claim 4, further comprising a flow displaying step of displaying a flow directed for execution by performing the first displaying step on a task contained in the flow directed for execution,
and wherein the second displaying step displays an execution sequence for the plurality of tasks.

6. The method according to claim 4, further comprising a flow display step of displaying a flow designated for editing by performing the first displaying step on a task contained in the flow directed for editing,
and wherein the second displaying step displays an execution sequence for the plurality of tasks.

7. The method according to claim 4, further comprising a task presentation step of displaying task by performing the first displaying step in order to present a task that is available for use in creation or editing of flow,
and wherein the second displaying step displays the plurality of tasks as individually usable.

8. An information processing method that executes a task in accordance with flow information that defines a cooperation processing of a plurality of tasks, comprising:
a first acquisition step of acquiring the next task to be executed, in accordance with task information contained in flow information;
a determination step of determining whether or not the task information acquired in the first acquisition step is being subdivided into a plurality of tasks;
a second acquisition step of acquiring the plurality of tasks in the event that it is determined that subdivision is taking place; and
an execution step of executing the task acquired in either the first acquisition step or the second acquisition step.

9. The method according to claim 8, further comprising:
an alternative processing determination step of determining whether or not each of the plurality of tasks acquired in the second acquisition step may be subject to alternative processing; and
an alternative processing execution step of executing alternative processing for a task that is determined to be subject to alternative processing in the alternative processing determination step.

10. The method according to claim 8, further comprising:
a parallel processing determination step of determining whether or not each of the plurality of tasks acquired in the second acquisition step may be subject to parallel processing; and
a parallel processing execution step of executing parallel processing for a task that is determined to be subject to parallel processing in the parallel processing determination step.

11. An information processing apparatus that manages flow information that defines a cooperation processing of a plurality of tasks, comprising:
an acquisition unit adapted to acquire update information that depicts a task subject to updating and a structure of the task after updating;
a detection unit adapted to detect task information, from registered flow information, corresponding to a task that is subject to updating, indicated by the update information; and
an update unit adapted to update the flow information by adding, to the task information detected by the detection unit, information that depicts task structure after updating that is depicted in the update information.

12. An information processing apparatus that display processes a task for constituting flow information that defines a cooperation processing of a plurality of tasks, comprising:
a determination unit adapted to determine whether or not a task to be displayed is being subdivided into a plurality of tasks, in accordance with task information of the task;
a first display unit adapted to display the task in a first format in the event that it is determined by the determination unit that the task is being subdivided, and in a second format that differs from the first format in the event that it is determined by the determination unit that the task is not being subdivided; and
a second display unit adapted to display a task as a plurality of subdivided tasks in the event that the task displayed in the first format is directed.

13. An information processing apparatus that executes a task in accordance with flow information that defines a cooperation processing of a plurality of tasks, comprising:
a first acquisition unit adapted to acquire the next task to be executed, in accordance with task information contained in flow information;
a determination unit adapted to determine whether or not the task information acquired by the first acquisition unit is being subdivided into a plurality of tasks;
a second acquisition unit adapted to acquire the plurality of tasks in the event that it is determined that subdivision is taking place according to the determination unit; and
an execution unit adapted to execute the task acquired by either the first or second acquisition unit.

14. An information processing system wherein a plurality of information processing apparatuses are connected via networks that possesses a server apparatus that registers and manages a task's task information and flow information that defines a cooperation processing of a plurality of tasks, comprising:
a generation unit adapted to generate, and supply to the server apparatus, update task information that depicts task structures before and after updating for a task that is subject to updating;
a detection unit adapted to detect task information that corresponds to a task that is subject to updating as depicted by the update task information, from flow information registered with the server apparatus;
a first update unit adapted to update the flow information by adding, to the task information detected by the detection unit, information that depicts task structure after update depicted in the update task information; and
a second update unit adapted to use the task information to update a corresponding task registered on the server apparatus.

15. The system according to claim 14, further comprising:
a first acquisition unit adapted to acquire the next task to be executed, in accordance with task information contained in flow information, on the server apparatus;
a determination unit adapted to determine whether or not the task1 information acquired in the first acquisition unit is being subdivided into a plurality of tasks;
a second acquisition unit adapted to acquire the plurality of tasks in the event that it is determined by the determination unit that subdivision is taking place; and
an execution unit adapted to execute the task acquired by either the first or second acquisition unit.

16. The information processing system according to claim 14, comprising:
a first determination unit adapted to determine in accordance with task information acquired from the server apparatus whether or not the task information is being subdivided into a plurality of tasks;
a first display unit adapted to display the task in a first format in the event that it is determined in the first determination unit that the task is being subdivided, and in a second format that differs from the first format in the event that it is determined in the first determination unit that the task is not being subdivided; and
a second display unit adapted to display the task as a plurality of subdivided tasks in the event that the task displayed in the first format is directed.

17. The execution unit according to claim 16, further comprising:
a first acquisition unit adapted to acquire the next task to be executed, in accordance with task information contained in flow information for which execution has been directed, on the server apparatus;
a determination unit adapted to determine whether or not the task information acquired in the first acquisition unit is being subdivided into a plurality of tasks;
a second acquisition unit adapted to acquire the plurality of tasks in the event that it is determined by the determination unit that subdivision is taking place; and
an execution unit adapted to execute the task acquired by either the first or second acquisition unit.

18. A control program stored in a computer readable medium, for executing, on a computer, the information processing method according to claim 1.

19. A storage containing a control program for executing, on a computer, the information processing method according to claim 1.
